(19) United States
(12) Patent Application Publication
(10) Pub. No.: US 2026/0202858 A1
(43) Pub. Date: Jul. 16, 2026

(54) LIQUID SUPPLY DEVICE, LIQUID SUPPLY METHOD, AND LIQUID SUPPLY PROGRAM

(71) Applicant: DIC Corporation, Tokyo (JP)

(72) Inventors: Yuichi Inoue, Kita-adachi-gun (JP); Kazuki Hayano, Kita-adachi-gun (JP); Marina Goto, Kita-adachi-gun (JP); Hiroshi Tsutsumi, Takaishi-shi (JP)

(73) Assignee: DIC Corporation, Tokyo (JP)

(21) Appl. No.: 19/136,989

(22) PCT Filed: Dec. 15, 2023
(86) PCT No.: PCT/JP2023/044999

§ 371 Date: Jun. 9, 2025

(30) Foreign Application Priority Data
Dec. 26, 2022 (JP) 2022-208001

(51) Int. Cl. G05D 1/648; B62D 57/024; G05D 105/45; G05D 107/90

(52) U.S. Cl. CPC G05D 1/6484; B62D 57/024; G05D 2105/45; G05D 2107/90

(57) ABSTRACT

[Object] To expand a region to be supplied with liquid compared with that by the known technique. [Solution] A liquid supply device including: a moving unit that moves in a state of supporting the liquid supply device; a supply unit that supplies liquid; a three-dimensional information acquisition unit that acquires three-dimensional information on an entire region potentially supplied with the liquid; a communication unit that transmits the three-dimensional information and receives information indicating a position of a supplied region supplied with the liquid in the entire region; and a control unit that controls the moving unit so that the liquid supply device moves to the supplied region based on three-dimensional information on the entire region and information indicating a position of the supplied region, and controls the supply unit so that the liquid is supplied to the supplied region.

### TECHNICAL FIELD

The present disclosure relates to a liquid supply device, a liquid supply method, and a liquid supply program.

### BACKGROUND ART

There is a known road marking device proposed including: a traveling dolly capable of autonomous travel; a camera mounted on the traveling dolly for picking up images in front thereof; a marking device mounted on the traveling dolly for drawing a center line on a road surface; a target placed on the road surface in front of the traveling dolly; and an electronic control unit mounted on the traveling dolly (Patent Literature 1). The electronic controller is configured to pick up an image including the target with the camera, then process the image to recognize the target, and draw a center line on the road surface with the marking device while traveling the traveling dolly toward the target.

### CITATION LIST

### Patent Literature

Patent Literature 1: JP 2022-148712 A

### SUMMARY OF INVENTION

### Technical Problem

However, the road marking device draws the center line on the road surface with the marking device while traveling the traveling dolly toward the target such that the target is positioned at the center of the image. Therefore, the region to be drawn has no expandability. First, the road marking device itself needs to dispose, at a desired position, a target having a plurality of special structures. Furthermore, in a case where a pattern or a figure is drawn, and in a case where the point of application is not decided in advance, specifically, in a case where of determining whether to perform application while scanning repair of a damaged portion or the like, it is difficult for the road marking device to cope with these.

An object of the technique of the present disclosure is to provide a liquid supply device, a liquid supply method, and a liquid supply program in which a region to be supplied with liquid is more expandable than those in the known technique.

### Solution to Problem

In order to achieve the above object, a liquid supply device of a first aspect of a technique of the present disclosure includes: a moving unit that moves in a state of supporting the liquid supply device; a supply unit that supplies liquid; a three-dimensional information acquisition unit that acquires three-dimensional information on an entire region potentially supplied with the liquid; a communication unit that transmits the three-dimensional information and receives information indicating a position of a supplied region supplied with the liquid in the entire region; and a control unit that controls the moving unit so that the liquid supply device moves to the supplied region based on three-dimensional information on the entire region and information indicating a position of the supplied region, and controls the supply unit so that the liquid is supplied to the supplied region.

A second aspect is a liquid supply method of the liquid supply device of the first aspect. The liquid supply method includes controlling the moving unit so that the liquid supply device moves to the supplied region based on three-dimensional information on the entire region and information indicating a position of the supplied region, and controlling the supply unit so that the liquid is supplied to the supplied region.
A liquid supply program of a third aspect causes a computer to function as the control unit of the first aspect.

### Advantageous Effects of Invention

The technique of the present disclosure can provide a liquid supply device, a liquid supply method, and a liquid supply program in which a region to be supplied with liquid is more expandable than those in the known technique.

### BRIEF DESCRIPTION OF DRAWINGS

FIG. 1 is a schematic view of a liquid supply system of a first embodiment.

FIG. 2 is a view illustrating a schematic configuration of a liquid supply device of the first embodiment.

FIG. 3 is a view illustrating a schematic configuration of an operator terminal device.

FIG. 4 is a timing chart illustrating an example of an action of the liquid supply system of the first embodiment.

FIG. 5 is a view illustrating an example of each of an entire region and a supplied region of the first embodiment.

FIG. 6 is a view illustrating an example of a position of a liquid supply device of a second embodiment when the liquid supply device repairs a wall surface of a building.

FIG. 7 is a view illustrating a schematic configuration of the liquid supply device of the second embodiment.

FIG. 8 is a timing chart illustrating an example of an action of the liquid supply system of the second embodiment.

FIG. 9 is a view illustrating an example of each of an entire region and a supplied region of the second embodiment.

### DESCRIPTION OF EMBODIMENTS

### First Embodiment

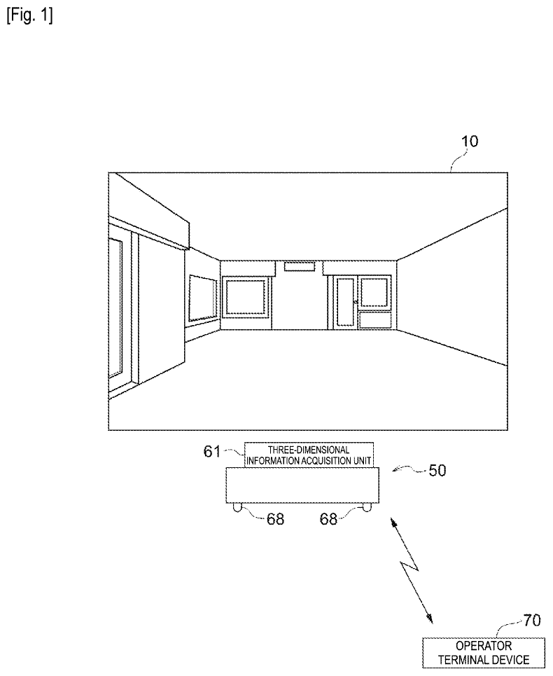

FIG. 1 is a schematic view illustrating an overall image of the liquid supply system according to the first embodiment. The liquid supply system according to the present embodiment includes: a liquid supply device 50 that applies a liquid or gel substance (liquid) such as paint, wax, and adhesive to a floor surface or the like that is a supplied region in a space 10 such as an indoor of a building; and an operator terminal device 70 that can perform wired or wireless communication with the liquid supply device 50 for an operator to control the liquid supply device 50.

At a relatively high position of the liquid supply device 50 such as the top of the liquid supply device 50, a three-dimensional information acquisition unit 61 that acquires information on a geometric feature such as a dimension or a shape indicating a layout of a supplied region is included. The three-dimensional information acquisition unit 61 irradiates the supplied region with an electromagnetic wave of as a laser or the like such as laser imaging detection and ranging (LIDAR), for example, and acquires the geometric feature of the supplied region by the electromagnetic wave scattered in the supplied region. In addition to LIDAR, a geometric feature of the supplied region may be acquired using image data acquired using a stereo camera that can acquire stereoscopic image data. Specifically, the geometric feature of a space including the supplied region is calculated by triangulation based on the parallax of two pieces of image data constituting the stereoscopic image data acquired by the stereo camera. Alternatively, the geometric feature of the supplied region may be acquired using a millimeter wave radar. Furthermore, the geometric feature of the supplied region may be acquired by integrating information obtained using each of the LIDAR, the stereo camera, and the millimeter wave radar. In the present embodiment, a processor 54 is configured to be able to acquire the geometric feature of the space including the supplied region by machine learning using data acquired by each of the LIDAR, the stereo camera, or the millimeter wave radar as training data.

Alternatively, information on the layout of the supplied region may be transmitted to the three-dimensional information acquisition unit 61 via the operator terminal device 70.

The liquid supplied to the supplied region by the liquid supply device 50 refers to a liquid composition (any liquid composition may be used, and solid content having a size of several tens of nm to several mm such as a pigment or other particles may be added). Examples thereof include ultraviolet (UV) curable wax, adhesive, waterproof coating, and paint. The supplied region, specifically, a supply target of the liquid is a flat surface such as a floor of a room or a rooftop of a building.

The liquid supply device 50 ejects the liquid to the supplied region by an inkjet method of discharging the liquid with fine droplets. In addition to the inkjet method, the liquid may be ejected to the supplied region by a spray method. When the substance to be supplied to the supplied region has a gel shape higher in viscosity than the liquid, the substance may be supplied to the supplied region by a member such as a roller impregnated or attached with the substance.

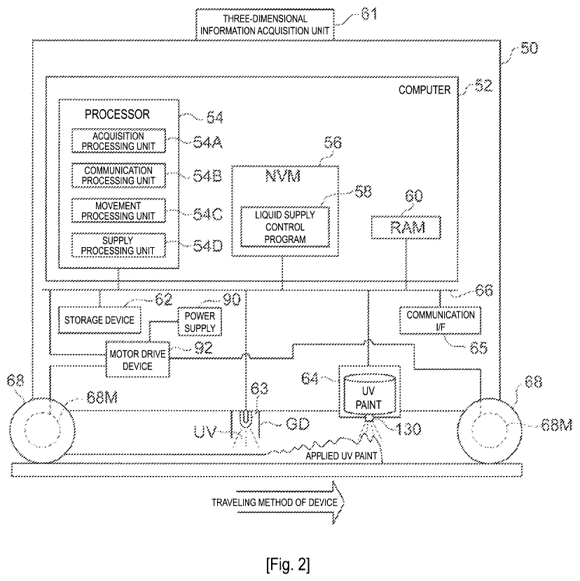

FIG. 2 is a block diagram illustrating an example of a hardware configuration and a main function of an electrical system of the liquid supply device 50 according to the present embodiment. The liquid supply device 50 includes a computer 52, a storage device 62, a UV lamp 63, an application device 64, a communication I/F 65, and a motor drive device 92. The UV lamp 63 is an example of the “ultraviolet supply unit” of the technique of the present disclosure. The application device 64 is an example of the “supply unit” of the technique of the present disclosure. The communication I/F 65 is an example of the “communication unit” of the technique of the present disclosure.

The computer 52 includes the processor 54, a non-volatile memory (NVM) 56, and a random access memory (RAM) 60. The processor 54, the NVM 56, and the RAM 60 are connected to a bus 66.

The processor 54 is an example of the “control unit” of the technique of the present disclosure.

The processor 54 is a processing device including a digital signal processor (DSP), a central processing unit (CPU), and a graphics processing unit (GPU), and the DSP and the GPU operate under the control of the CPU and carry out the execution of the processing described later. Here, an example of the processor 54 is a processing device including a DSP, a CPU, and a GPU, but this is merely an example, and the processor 54 may be one or more CPUs and DSPs in which GPU functions are integrated, may be one or more CPUs and DSPs in which GPU functions are not integrated, or may be mounted with a tensor processing unit (TPU).

The NVM 56 is a non-volatile storage device that stores various programs, various parameters, and the like. Examples of the NVM 60 include a flash memory (e.g., electrically erasable and programmable read only memory (EEPROM)). The RAM 60 is a memory temporarily storing information, and is used as a work memory by the processor 54. Examples of the RAM 60 include a dynamic random access memory (DRAM) and a static random access memory (SRAM).

In the present embodiment, the NVM 56 stores a liquid supply control program 58. The processor 54 deploys the liquid supply control program 58 into the RAM 60 and executes the program. When the processor 54 executes the liquid supply control program 58, the processor 54 functions as an acquisition processing unit 54A, a communication processing unit 54B, a movement processing unit 54C, and a supply processing unit 54D. Note that the liquid supply control program 58 may be stored in the storage device 62. The liquid supply control program 58 is an example of the “liquid supply program” of the technique of the present disclosure.

The communication I/F 65 is an interface including a communication processor and an antenna, and is connected to the bus 66. The communication standard applied to the communication I/F 65 is, for example, a wireless communication standard including the 5th generation mobile communication system (5G), Wi-Fi (registered trademark), or Bluetooth (registered trademark).

The storage device 62 is a non-volatile storage device, and is, for example, a solid state drive (SSD), a hard disk drive (HDD), or the like.

The application device 64 applies a liquid substance such as UV paint, for example, to the supplied region by the inkjet method or the like based on a command from the supply processing unit 54D of the processor 54. The substance such as UV paint is ejected from a nozzle 130 and applied to the supplied region. The applied UV paint or the like cures by UV emitted from the UV lamp 63 controlled by the supply processing unit 54D. A protection member GD is provided around the UV lamp 63 so as to prevent attachment of the liquid ejected by the application device 64.

The nozzle 130 for the paint may be present at a bottom surface of the present device, or may have a form of extending from the present device by an arm or the like. Note that when a UV curable composition is used, the UV lamp 63 may be disposed at the tip of the arm together with the nozzle. At that time, the nozzle 130 for the paint may be arranged in a forward direction and the UV lamp 63 may be arranged in a rearward direction with respect to the travel direction.
The UV lamp 63 may include an LED having an output peak at a wavelength of 300 to 420 nm in order to reduce the size and weight of the liquid supply device 50.

The liquid supply device 50 includes four wheels 68 near four corners of a housing, and is configured to be freely movable through the supplied region by performing forward movement, backward movement, right turning, and left turning. Each of the four wheels 68 of the liquid supply device 50 includes a motor 68M that rotates the wheel 68, and each of the motors 68M is driven by the power of a power supply 90 supplied via the motor drive device 92.

The four wheels 68, the four motors 68M, and the motor drive device 92 are examples of the “moving unit” of the technique of the present disclosure, and are not limited to this form. The number of wheels may be other than four, or the wheels may be in the form of a caterpillar.

The power supply 90 is, for example, a secondary battery that can charge and discharge such as a lithium ion battery, a nickel-metal hydride battery, a nickel-cadmium battery, or a lead-acid battery. The power supply 90 may be supplied from the outside by wire.

The liquid supply device 50 can move forward or backward by changing the rotation direction of the four wheels 68. The liquid supply device 50 can turn left or right by controlling the rotation speed of each of the four wheels 68. For example, when the liquid supply device 50 turns right, the rotation speed of the two wheels 68 on the right side of the liquid supply device 50 is suppressed more than the rotation speed of the wheels 68 on the left side. When the liquid supply device 50 turns left, the rotation speed of the two wheels 68 on the left side of the liquid supply device 50 is suppressed more than the rotation speed of the wheels 68 on the right side.

The motor drive device 92 modulates and supplies, to the motor 68M, the power of the power supply 90 based on a control signal from the movement processing unit 54C of the processor 54 via the bus 66. When the motor 68M is a three-phase synchronous motor such as a brushless motor, for example, the motor drive device 92 is an inverter that applies, to a winding of the motor 68M, a three-phase alternating-current voltage obtained by pulse width modulation (PWM) of the power of the power supply 90 that is direct-current. Based on a command from the movement processing unit 54C, by altering the frequency of the three-phase alternating-current voltage supplied to each of the motors 68M and the execution voltage, the motor drive device 92 changes the rotation speed and the rotation direction of the motor 68M and causes the liquid supply device 50 to move forward, move backward, turn right, and turn left. Alternatively, the wheels 68 may be provided with a steering mechanism, and the steering mechanism may cause the liquid supply device 50 to turn right and turn left. Since the movement of the liquid supply device 50 is performed by rotating the wheels by the motor as described above, it is possible to prevent unnecessary air flow and vibration from occurring.

A tire surface of the wheel 68 is provided with a release agent layer. This can enhance releasability of the tire surface, and even when the tire surface is placed on a supplied region in which an applied liquid is UV cured, can suppress the tire surface from adhering to the substance in which the applied liquid is UV cured.

In the present embodiment, in addition to the liquid supply device 50 that is an application robot, it is possible to operate in combination with a cleaning robot that cleans the supplied region. The cleaning robot ejects cleaning liquid by the application device 64 of the liquid supply device 50 to clean the surface of the supplied region. If the supplied region is already clean, only the liquid supply device 50, which is an application robot, may be operated without using the cleaning robot in combination. The cleaning robot may have a function of wiping off or blowing off dust with air after ejecting the cleaning liquid.

The liquid supply device 50 may include various sensors. The sensors include, first, a length measuring sensor that measures a distance between a liquid supply unit 130 on a lower surface in FIG. 2 and an application surface. When there is a change in the distance, the liquid supply device 50 adjusts at least one of the discharge amount or the moving speed. The sensors include, second, an ultrasonic sensor that transmits an ultrasonic wave radially toward the travel direction and receives a reflected ultrasonic wave. The liquid supply device 50 has a function of determining whether an object that potentially collides with the liquid supply device 50 exists in the travel direction based on a reception state of the ultrasonic wave by the ultrasonic sensor, and, upon determining that the object exists, traveling while avoiding the object or pausing or alarming.

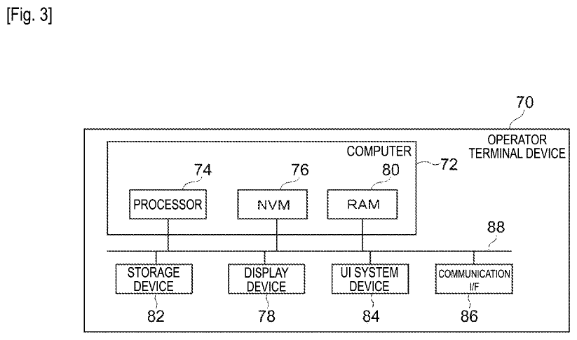

FIG. 3 is a block diagram illustrating an example of the configuration of the operator terminal device 70. The operator terminal device 70 includes a computer 72, a storage device 82, a display device 78, a UI system device 84, and a communication I/F 86.

The computer 72 includes a processor 74, an NVM 7, and a RAM 80. The processor 54, the NVM 56, and the RAM 60 are connected to a bus 88. The storage device 82, the display device 78, the UI system device 84, and the communication I/F 86 are also connected to the bus 88. The UI system device 84 is an input device such as a mouse, a keyboard, or a touch panel in the display device 78, and an interface such as a universal serial bus (USB). The display device 78 is a monitor such as a liquid crystal display (LCD). The communication I/F 86 is configured to be able to communicate with the communication I/F 65 of the liquid supply device 50 in a wired or wireless manner. The NVM 7 or the storage device 82 stores a supplied region instruction program.

The technique of the present disclosure may use a portable terminal device, for example, a smartphone or a tablet device in place of the operator terminal device 70 configured in this manner. A program for instructing operation of the liquid supply device 50 may be installed in such a portable terminal device, and instruction may be given for the operation of the liquid supply device 50 by executing the program.

In the present embodiment, the three-dimensional information acquisition unit 61 of the liquid supply device 50 acquires the geometric feature of the supplied region, but information on the layout or the like of the supplied region may be registered in advance in the storage device 82, and may be transmitted to the communication 1/F 86 of the liquid supply device 50 via the communication 1/F 65 at the time of work. The registration of the information on the storage device 82 may be input via the UI system device 84 or may be input via an interface such as a USB.

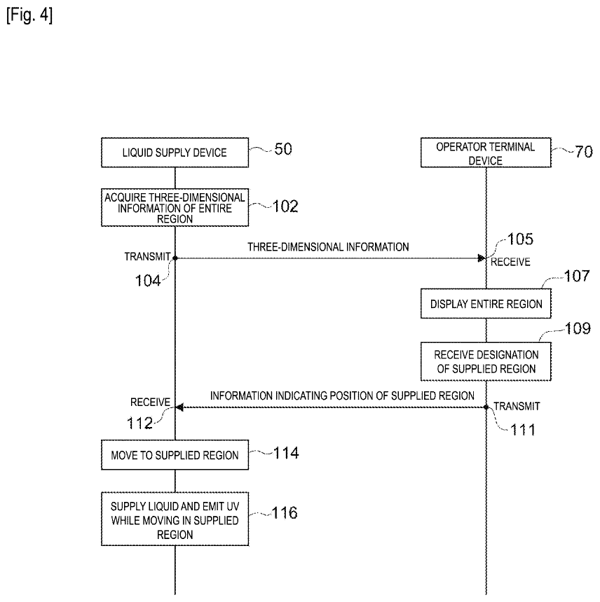

FIG. 4 is a timing chart illustrating an example of processing of the liquid supply system according to the present embodiment. The timing chart of FIG. 4 includes liquid supply control processing (left side) executed by the processor 54 of the liquid supply device 50 executing the liquid supply control program, and supplied region instruction processing (right side) executed by the processor 74 of the operator terminal device 70 executing the supplied region instruction program. In each of the liquid supply control processing and the supplied region instruction processing, the corresponding steps are executed in descending order.

In step 102, in the liquid supply device 50, the three-dimensional information acquisition unit 61 acquires three-dimensional information on the entire region including the supplied region under the control of the acquisition processing unit 54A of the processor 54. The technique of the present disclosure is not limited to the liquid supply device 50 autonomously acquiring three-dimensional information by the three-dimensional information acquisition unit 61. For example, an instruction signal for moving the liquid supply device 50 may be transmitted from the operator terminal device 70 operated by an operator, and the liquid supply device 50 may be moved to a region including the entire region, and the three-dimensional information may be acquired. In step 104, the acquired three-dimensional information is transmitted to the operator terminal device 70 via the communication I/F 65 under the control of the communication processing unit 54B of the processor 54. Then, in step 105, the operator terminal device 70 receives the three-dimensional information via the communication I/F 86.

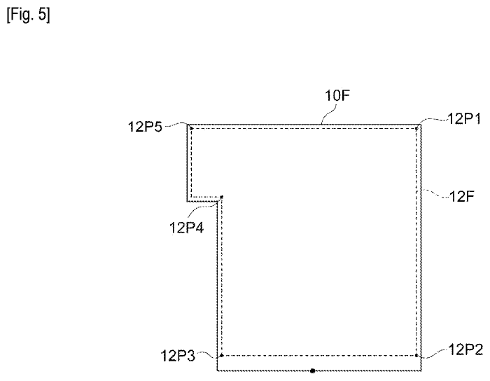

In step 107, an entire region 10F indicating a floor surface of the received three-dimensional information is displayed on the display device 78. FIG. 5 is an explanatory view illustrating an example of the entire region (e.g., floor surface) 10F displayed on the display device 78.

On the operator terminal device 70 side, the operator views an image of the entire region displayed on the display device 78 and designates a supplied region 12F supplied with liquid.

In step 109, the designation of the supplied region 12F is received. In the present embodiment, as illustrated in FIG. 5, coordinates 12P1, 12P2, 12P3, 12P4, and 12P5 are designated in the entire region 10F displayed on the display device 78, and the inside of line segments each connecting the corresponding adjacent two of the coordinates 12P1 to 12P5 is set as the supplied region. The designation of the coordinates 12P1 to 12P5 is input via a pointing device such as a mouse that is the UI system device 84 or the display device 78 functioning as a touch panel.

In step 111, information on the supplied region 12F designated via the communication I/F 86 is transmitted to the communication I/F 65 of the liquid supply device 50.

In step 112, the communication I/F 65 receives information on the supplied region under the control of the communication processing unit 54B of the liquid supply device 50.

In step 114, under the control of the movement processing unit 54C, the wheels 68 are rotated to move the liquid supply device 50 to the supplied region 12F.

In step 116, under the control of each of the movement processing unit 54C and the supply processing unit 54D, while moving the liquid supply device 50 in the supplied region 12F, liquid such as UV paint is ejected onto the surface of the supplied region 12F, and the UV lamp 63 irradiates the supplied region 12F with UV to cure the applied liquid.

As an example, the application order in the supplied region is controlled by AI constructed by causing the processor 54 to perform machine learning of an efficient application order with data. In the present embodiment, efficient movement is performed such that the liquid supply device 50 does not move through an applied surface as much as possible. For example, by performing unicursal drawing based on a graph theory, the liquid supply device 50 is prevented, as much as possible, from moving on the applied surface. In order to enable unicursal drawing based on the graph theory, a figure indicating a trajectory in the supplied region 12F of the liquid supply device 50 is what is called an Euler graph. The Euler graph is a figure in which the number of vertices whose degree (the number of sides connected to the vertices) is odd among the vertices of the figure is 2 or 0. Alternatively, a sensor such as an image pickup device may recognize a positional relationship between a region where coating has already been cured and a region to be coated next, perform position adjustment, and perform control so that desired application can be performed at a predetermined position.

When moving the liquid supply device 50 in the supplied region 12F, the movement processing unit 54C determines, based on the three-dimensional information, whether there is an object with which the liquid supply device 50 potentially collides, and, upon determining that there is the object, moves the liquid supply device 50 while avoiding the object. The technique of the present disclosure is not limited to the liquid supply device 50 autonomously moving while avoiding the object upon determining that there is the object. For example, upon determining that there is the object, the liquid supply device 50 stops the movement before colliding, and transmits, to the operator terminal device 70, an alert signal indicating that there is an object with which the liquid supply device 50 potentially collides. Upon receiving the alert signal, the operator terminal device 70 displays, on the display device 78, that there is an object with which the liquid supply device 50 potentially collides. The operator who views this display operates the operator terminal device 70, transmits a movement instruction signal from the operator terminal device 70 to the liquid supply device 50, and moves the liquid supply device 50 so as to avoid the object.

The movement of the liquid supply device 50 may be controlled not only by the autonomous control in the liquid supply device 50 but also by a control signal received via the communication I/F 65.

As described above, according to the present embodiment, while self-propelling in the supplied region 12F designated by the operator in the entire region 10F indicating the floor surface of the three-dimensional information acquired by the three-dimensional information acquisition unit 61, the liquid supply device 50 ejects the liquid into the supplied region 12F. As a result, it is possible to construct a liquid supply system in which a region to be supplied with liquid is more expandable than those in the known technique.

When the processing proceeds to step 116 in FIG. 4, for example, the liquid supply device 50 according to the present embodiment acts autonomously without human control, and therefore there is no inconvenience of requiring constant user operation.

In the present embodiment, application of liquid to the supplied region 12F has been described, but the present invention is not limited to this. For example, as in the second embodiment described later, the liquid supply device 50 may include a determination information acquisition unit 96 that acquires image data or the like of the surface of the supplied region 12F, detect or determine a structure or a pattern designated in advance in the supplied region, specifically, a damaged site such as a hole or a crack from the image data or the like acquired by the determination information acquisition unit 96, and apply or fill a detected damaged site with a repair material.

In order to detect the damaged site from layer data or the like, the processor 54 is constructed to function as a determination unit by machine learning with image data including a damaged point as training data.

### Second Embodiment

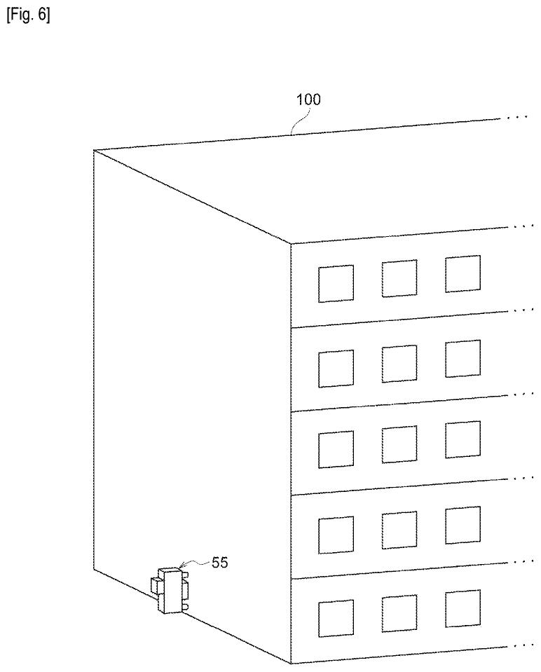

Next, the second embodiment will be described. As illustrated in FIG. 6, the present embodiment is different from the first embodiment in that a liquid supply device 55 moves on a wall surface of a building 100 or the like and supplies liquid to the wall surface. In the present embodiment, the liquid supply device 55 is applicable also to grasp and fix and repair of a state of a wall surface in a tunnel or a pipe in addition to the wall surface.

In the present embodiment, the liquid to be supplied is a repair material (filler), and the liquid supply device 55 fills the repair material (filler) into a structure or a pattern designated in advance on the wall surface, specifically, a hole or a crack, by inkjet or spray.

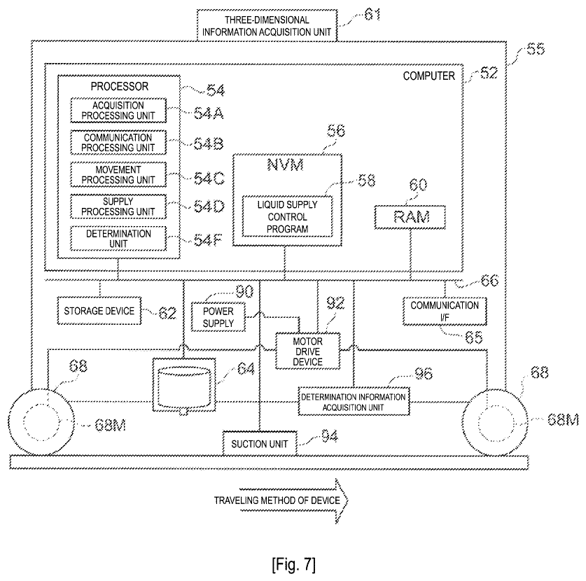

FIG. 7 is a block diagram illustrating an example of a hardware configuration and a main function of an electrical system of the liquid supply device 55 according to the second embodiment. The liquid supply device 55 is different from that of the first embodiment in including a suction unit 94 that sucks a wall surface of the building 100 in order to apply liquid by moving on the wall surface, and the determination information acquisition unit 96 that acquires determination information for determining whether a designated supplied region is appropriate as a region to be supplied with the liquid, and the processor 54 functions as a determination unit 54F that determines whether the supplied region designated based on the information acquired by the determination information acquisition unit 96 is appropriate as a region to be supplied with the liquid. However, other configurations are identical to those of the first embodiment, and therefore these configurations are given identical reference signs to those of the first embodiment, and a detailed description thereof will be omitted.

The suction unit 94 is an example of the “adsorption unit” of the technique of the present disclosure.

The determination information acquisition unit 96 is, for example, an image pickup device such as a camera that acquires image data of the surface of a supplied region, and the determination unit 54F of the processor 54 performs image analysis on the image data acquired by the determination information acquisition unit 96, and detects or determines whether there is a structure or a pattern designated in advance, specifically, a hole or a crack in the supplied region. The determination information acquisition unit 96 may include an actuator that taps a wall surface of the supplied region and a microphone that acquires sound data of the actuator tapping the wall surface. The determination unit 54F of the processor 54 detects or determines existence of a hole or a crack on the wall surface based on the sound data acquired by the microphone. The technique of the present disclosure is not limited to the microphone. For example, a vibration sensor may be used. Specifically, the vibration sensor detects the magnitude of vibration of the actuator tapping the wall surface, and the determination information acquisition unit 96 detects or determines existence of a hole or a crack on the wall surface based on a detection result.

In the present embodiment, the liquid supply device 55 moves through the supplied region on the wall surface by rotating the wheels 68 while the suction unit 94 holds the liquid supply device 55 on the wall surface by suction of air. When the wall surface is made of a magnetic material such as iron and steel, the suction unit 94 may hold the liquid supply device 55 onto the wall surface by suction by a magnetic force in place of suction by air. Furthermore, the liquid supply device 55 may be a drone that can fly near the wall surface and can perform stationary flight in the supplied region.

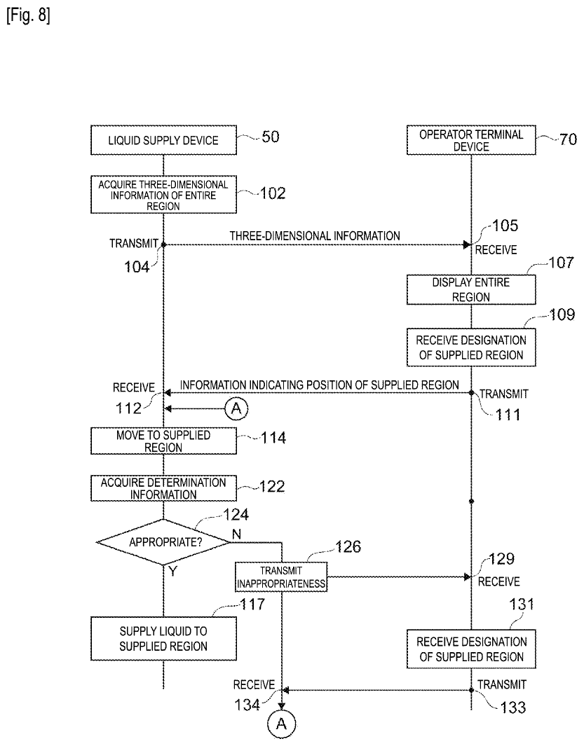

FIG. 8 is a timing chart illustrating an example of processing of the liquid supply system according to the present embodiment. Steps 102 to 114 and 116 in the processing of the liquid supply system according to the present embodiment are the same as those in the first embodiment, and thus detailed description thereof is omitted.

In step 122, the determination information acquisition unit 96 acquires information on the surface of the supplied region where the liquid supply device 55 is positioned.

In step 124, by detecting or determining whether the surface of the supplied region has a structure or a pattern designated in advance, specifically, a hole or a crack, the determination unit 54F of the processor 54 determines whether the supplied region is appropriate. In step 124, if the surface of the supplied region has a hole or a crack (when the supplied region is appropriate), the liquid supply control processing proceeds to step 117 and the supplied region is supplied with the liquid. Specifically, the supply processing unit 54D supplies the liquid only to a part of a hole or a crack in the supplied region, that is, a part requiring repair.

In step 124, if the surface of the supplied region where the liquid supply device 55 is positioned has no hole or no crack (when the supplied region is inappropriate), the liquid supply control processing proceeds to step 126.

In step 126, the fact that the surface of the supplied region has no hole or no crack and the region is an inappropriate region is transmitted to the operator terminal device 70 via the communication I/F 65 under the control of the communication processing unit 54B.

In step 129, the operator terminal device 70 receives, via the communication I/F 86, information indicating that the surface of the supplied region where the liquid supply device 55 is positioned is an inappropriate region.

In step 131, the designation of the supplied region is received again and transmitted to the liquid supply device 55. Note that between step 129 and step 131, the display device 78 may display the information that the currently designated supplied region is inappropriate. Note that the inappropriate supplied region is not a part that has no hole or no crack on the surface of the supplied region and requires repair, and hence is a region not requiring liquid supply.

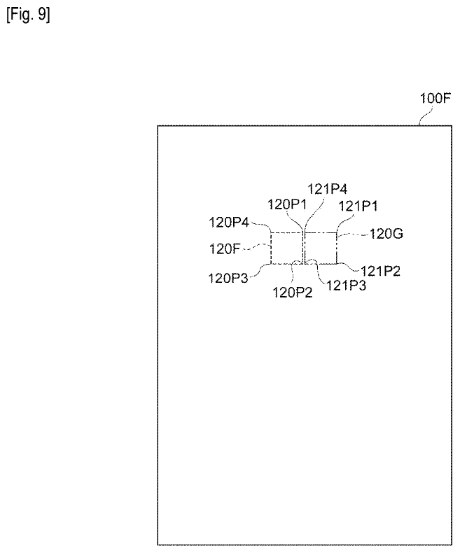

FIG. 9 is an explanatory view related to setting of a supplied region in an entire region 100F indicating a wall surface. FIG. 9 displays a supplied region 120F designated first and a supplied region 120G newly designated after the supplied region 120F is determined to be inappropriate. As illustrated in FIG. 9, in the supplied region 120F designated first, coordinates 120P1, 120P2, 120P3, and 120P4 are designated in the entire region 100F displayed on the display device 78, and the inside of line segments each connecting the corresponding adjacent two of the coordinates 120P1 to 120P4 is set as the supplied region 120F. The designation of the coordinates 120P1 to 120P4 is input via a pointing device such as a mouse that is the UI system device 84 or the display device 78 functioning as a touch panel. Similarly in the supplied region 120G newly designated, similarly, coordinates 121P1, 121P2, 121P3, and 121P4 are designated in the entire region 100F displayed on the display device 78, and the inside of the line segments each connecting the corresponding adjacent two of the coordinates 121P1 to 121P4 is set as the supplied region 120G newly designated.

In step 133, information on the supplied region 120G newly designated that is designated via the communication I/F 86 is transmitted to the communication I/F 65 of the liquid supply device 55.

In step 134, the communication I/F 65 receives the information on the supplied region under the control of the communication processing unit 54B of the liquid supply device 55. After the reception of step 134, the liquid supply control processing proceeds to step 114. The liquid supply device 55 moves to the supplied region 120G newly designated and executes similar processing described above.

Note that in place of steps 126 to 134, the liquid supply device 55 may autonomously decide a new supplied region. Specifically, when the supplied region 120F designated first is inappropriate, the liquid supply device 55 decides, as a new supplied region, a region other than the supplied region 120F in the entire region 100F, for example, a region around the supplied region 120F, specifically, a region adjacent to the supplied region 120F. Note that the new supplied region needs not be adjacent to the supplied region 120F as long as it is a region other than the supplied region 120F in the entire region 100F.

Upon receiving information indicating that the surface of the supplied region where the liquid supply device 55 is positioned is an inappropriate region via the communication I/F 86 in step 129, the operator terminal device 70 may issue an alert prompting the operator to designate the supplied region again. Note that the alert is issued by, for example, displaying the alert by sound or turning on an alarm lamp. This allows the operator not to constantly check the display content of the display device.

In the present embodiment, description has been given regarding detecting or determining the structure or the pattern designated in advance of the supplied region, specifically, the damaged site such as a hole or a crack, and applying or filling the detected damaged site with the repair material, but the present invention is not limited to this. For example, the liquid supply device 50 may be configured to apply liquid such as UV curable paint to the supplied region and then cure the applied liquid by UV emitted from a UV lamp.

In the present embodiment, an entire surface transparent coat may be applied to the supplied region, or at least one of a specific figure or a pattern may be formed.

As a first modification of the present embodiment, coating or waxing is performed on a stereoscopic surface. The stereoscopic surface is a wall surface of a building having a curved surface structure such as a spherical surface, an elliptical surface, or a hyperbolic surface, a body surface of an aircraft, or the like. In the first modification, the liquid supply device 55 autonomously moves through such a curved surface structure and performs coating or waxing.

A second modification is related to repair of a flat surface such as a floor. For example, when the wax on the floor surface becomes thin, in the second modification, the floor surface is waxed by the liquid supply device 55.

As described above, according to the present embodiment, when moving to the designated supplied region, the liquid supply device 55 detects or determines presence or absence of a structure or a pattern designated in advance in the supplied region, specifically, a point needing repair such as a hole or a crack, thereby determining whether the supplied region is appropriate as a region to be supplied with the liquid. If the supplied region has a point needing repair and is appropriate, liquid is autonomously supplied to the supplied region, and if the supplied region has no point needing repair and is inappropriate, the fact is transmitted to the operator terminal device 70. Then, the operator terminal device designates the supplied region again and transmits the designation to the liquid supply device, and the liquid supply device 55 determines whether the newly designated supplied region is appropriate or inappropriate, and supplies the liquid to the supplied region if the supplied region is appropriate.

The liquid supply device 55 according to the present embodiment basically acts autonomously on the wall surface without human control, and therefore there is no inconvenience of requiring constant user operation unlike the known technique. When there is no point needing repair in the supplied region of a destination, the liquid supply device 55 autonomously moves to the reset supplied region, and therefore the region supplied with the liquid can be made more expandable than that in the known technique.

### Other Modifications

As described above, the liquid supply device 50 and the liquid supply device 55 can use the following various processors. Examples of the processor include software, that is, a CPU that is a general-purpose processor functioning as a hardware resource that executes the liquid supply control processing by executing a program. Examples of the processor include a dedicated electric circuit that is a processor having a circuit configuration exclusively designed for executing specific processing such as FPGA, PLD, or ASIC. A memory is built in or connected to any processor, and any processor executes the liquid supply control processing by using the memory.

The hardware resource that executes the liquid supply control processing may be configured by one of these various processors, or may be configured by a combination of two or more processors of the same type or different types (e.g., a combination of a plurality of FPGAs or a combination of a CPU and an FPGA).

Examples of the configuration with one processor include, first, a form in which one processor is configured by a combination of one or more CPUs and software, and this processor functions as a hardware resource that executes the liquid supply control processing. Second, as represented by SoC and the like, there is a form of using a processor that implements, with one IC chip, a function of the entire system including a plurality of hardware resources that execute the liquid supply control processing. In this manner, the liquid supply control processing is implemented using one or more of the above-described various processors as hardware resources.

Furthermore, more specifically, an electric circuit in which circuit elements such as semiconductor elements are combined can be used as a hardware structure of these various processors. The target speed selection processing described above is merely an example. Therefore, it is needless to mention that unnecessary steps may be deleted, new steps may be added, and the processing order may be replaced within a range not departing from the gist.

The description content and illustration content given above are detailed descriptions of parts related to the technique of the present disclosure, and are merely examples of the technique of the present disclosure. For example, the above descriptions regarding the configuration, function, action, and effect are descriptions regarding an example of the configuration, function, action, and effect of the part related to the technique of the present disclosure. Therefore, it is needless to mention that unnecessary parts may be deleted, new elements may be added, and replacement may be made with respect to the description content and illustration content given above within a range not departing from the gist of the technique of the present disclosure. In order to avoid complication and to facilitate understanding of the part related to the technique of the present disclosure, in the description content and illustration content given above, description regarding technical common sense or the like that requires no particular description in enabling implementation of the technique of the present disclosure is omitted.

All literature, patent applications, and technical standards described in the present description are incorporated herein by reference to the same extent as individual literature, patent applications, and technical standards are specifically and individually indicated to be incorporated by reference.

### REFERENCE SIGNS LIST

10F Entire region
12F Supplied region
50 Liquid supply device
52 Computer
54 Processor
54A Acquisition processing unit
54B Communication processing unit
54C Movement processing unit
54D Supply processing unit
54F Determination unit
55 Liquid supply device
56 NVM
58 Liquid supply control program
60 RAM
61 Dimensional information acquisition unit
62 Storage device
63 UV lamp
64 Application device
65 Communication I/F
66 Bus
68 Wheels
68M Motor
70 Operator terminal device
72 Computer
74 Processor
76 NVM
78 Display device
82 Storage device
84 UI system device
86 Communication I/F
90 Power supply
92 Motor drive device
94 Suction unit
96 Determination information acquisition unit
100 Building
100F Entire region
120F, 120G Supplied region
130 Nozzle

1. A liquid supply device comprising:
a moving unit configured to move in a state of supporting the liquid supply device;
a supply unit configured to supply liquid;
a three-dimensional information acquisition unit configured to acquire three-dimensional information on an entire region potentially supplied with the liquid;
a communication unit configured to transmit the three-dimensional information and receive information indicating a position of a supplied region supplied with the liquid in the entire region; and
a control unit configured to control the moving unit so that the liquid supply device moves to the supplied region based on three-dimensional information on the entire region and information indicating a position of the supplied region, and control the supply unit so that the liquid is supplied to the supplied region.

2. The liquid supply device according to claim 1 further comprising a determination information acquisition unit configured to acquire determination information for determining whether the supplied region is appropriate as a region to be supplied with the liquid in a state where the liquid supply device arrives at the supplied region,
wherein
the control unit determines whether the supplied region is appropriate as a region to be supplied with the liquid based on the determination information, and, upon determining that the supplied region is appropriate as a region to be supplied with the liquid, controls the supply unit so that the liquid is supplied to the supplied region.

3. The liquid supply device according to claim 2, wherein if not determining that the supplied region is appropriate as a region to be supplied with the liquid, the control unit newly sets a region other than the supplied region in the entire region as the supplied region, and, upon determining that the set supplied region is appropriate as a region to be supplied with the liquid, controls the supply unit so that the liquid is supplied to the supplied region.

4. The liquid supply device according to claim 3, wherein information indicating a position of a region newly set as the supplied region is received by the communication unit or is decided by the control unit based on the three-dimensional information.

5. The liquid supply device according to claim 3, wherein
the determination information acquisition unit acquires image data of a surface of the supplied region, and
upon detecting or determining a structure or a pattern designated in advance in the supplied region from the image data, the control unit determines that the supplied region is appropriate as a region supplied with the liquid.

6. The liquid supply device according to claim 3, wherein
the determination information acquisition unit includes an actuator configured to tap the supplied region and a microphone configured to acquire sound data of the actuator tapping the supplied region, and
upon detecting a structure or a pattern designated in advance in the supplied region based on sound data acquired by the microphone, the control unit determines that the supplied region is appropriate as a region supplied with the liquid.

7. The liquid supply device according to claim 5, wherein the control unit controls the supply unit so that the liquid is supplied to the damaged site.

8. The liquid supply device according to claim 1, further comprising:
an adsorption unit configured to adsorb to a wall surface,
wherein
the control unit controls the moving unit so as to move on a wall surface while holding the liquid supply device by suction by the adsorption unit.

9. The liquid supply device according to claim 8, wherein the adsorption unit holds the liquid supply device by any method of adsorbing to the wall surface by sucking air or adsorbing to the wall surface by magnetic force.

10. The liquid supply device according to claim 1, wherein the control unit controls the moving unit so as to move through the supplied region unicursally based on a graph theory.

11. The liquid supply device according to claim 1, wherein in a case where the liquid supply device moves to the supplied region, the control unit controls the moving unit so that the liquid supply device moves to a part other than a part where the liquid has been supplied to the supplied region by the moving unit and the supply unit.

12. The liquid supply device according to claim 1, wherein
the liquid cures upon irradiation with ultraviolet,
the liquid supply device further includes an ultraviolet irradiation unit configured to emit ultraviolet, and
the control unit controls the ultraviolet irradiation unit so that the liquid supplied to the supplied region is irradiated with the ultraviolet.

13. The liquid supply device according to claim 1, wherein
the moving unit includes
a plurality of wheels,
a plurality of motors configured to rotate each of the plurality of wheels, and
a motor drive device configured to drive each of the plurality of motors.

14. The liquid supply device according to claim 13, wherein a surface of the wheel is provided with a release agent layer.

15. The liquid supply device according to claim 1, wherein the supply unit discharges the liquid with fine droplets.

16. A liquid supply method of the liquid supply device described in claim 1, the liquid supply method comprising
controlling the moving unit so that the liquid supply device moves to the supplied region based on three-dimensional information on the entire region and information indicating a position of the supplied region, and controlling the supply unit so that the liquid is supplied to the supplied region.

17. A liquid supply program causing a computer to function as the control unit described in claim 1.
